(19) United States
(12) Patent Application Publication
(10) Pub. No.: US 2007/0271121 A1
(43) Pub. Date: Nov. 22, 2007

(54) Method And System For Providing Evidence Based Evaluations Of Medical Treatments

(75) Inventors: Ken LAUDAN, Mission Hills, KS (US); Andrew COPE, Prairie Village, KS (US); Gregory FAY, Prairie Village, KS (US); Eddy Dywayne Johnson, Kansas City, MO (US)

Correspondence Address: LATHROP & GAGE LC, 2345 GRAND AVENUE, SUITE 2800, KANSAS CITY, MO, 64108, US

(73) Assignee: CONSUMERMED, INC., Prairie Village, KS (US)

(21) Appl. No.: 11/737,507

(22) Filed: Apr. 19, 2007

Related U.S. Application Data
(60) Provisional application No. 60/793,287, filed on Apr. 19, 2006.
(60) Provisional application No. 60/796,225, filed on Apr. 28, 2006.
(60) Provisional application No. 60/912,366, filed on Apr. 17, 2007.

(51) Int. Cl. G06Q 50/00; G06F 19/00

(52) U.S. Cl. 705/3; 705/2

(57) ABSTRACT

Methods and systems for securing and providing evidence based evaluations of medical treatments are disclosed herein. A method according to one embodiment includes: providing guidelines for selecting evidence about the treatments; selecting a research expert knowledgeable about evidence relating to the treatments; having the research expert select evidence relating to the treatments; selecting a group of treatment experts knowledgeable about the treatments; having the treatment experts evaluate the treatments based on the evidence relating to the treatments; and placing the evaluations in a database accessible by users. A method according to an embodiment includes: providing a database of treatment evaluations based on evidence relating to the treatments; securing personal medical information related to medical conditions to be treated by the treatments; securing consumer selection criteria; preparing personalized medical plans based on the personal medical information, the treatment evaluations, and the selection criteria; and providing the personalized medical plans.

### RELATED APPLICATIONS

This application claims priority to U.S. Provisional Application No. 60/793,287, filed Apr. 19, 2006, U.S. Provisional Application No. 60/796,225, filed Apr. 28, 2006; and U.S. Patent Application No. 60/912,366, filed Apr. 17, 2007. All of the aforementioned patent applications are incorporated herein by reference.

### BACKGROUND

The invention relates generally to evaluating medical treatments and providing those evaluations to users (individual healthcare consumers, employers, employees, health plan members, healthcare providers, physicians, nurses, insurance companies, etc.) While extensive evidence about medical treatments exists, users often do not know how reliable various evidence is. In addition, users may have difficulty obtaining evidence about medical treatments, may not have the time to compile evidence about medical treatments, and may further have difficulty in understanding even reliable and accessible evidence.

### SUMMARY

A method of securing and providing evidence based evaluations of medical treatments according to an embodiment includes steps: (a) providing guidelines for selecting evidence about the treatments; (b) selecting a research expert knowledgeable about evidence relating to the treatments; (c) having the research expert select evidence relating to the treatments; (d) selecting a group of treatment experts knowledgeable about the treatments; (e) having the treatment experts evaluate the treatments based on the evidence relating to the treatments; and (f) placing the evaluations in a database accessible by users.

A method of providing personalized medical plans for consumers according to an embodiment includes steps: (a) providing a database of treatment evaluations based on evidence relating to the treatments; (b) securing personal medical information from the consumers related to medical conditions to be treated by the treatments; (c) securing selection criteria from the consumers, the selection criteria selected from the group consisting of effectiveness, safety, tolerability, and cost; (d) preparing personalized medical plans for the consumers based on the personal medical information, the treatment evaluations, and the selection criteria; and (e) placing the personalized medical plans in a database accessible by at least one of the consumers and a healthcare provider.

A system for securing and providing evidence-based evaluations of medical treatments for various healthcare conditions according to an embodiment includes a computing device having a database; at least one remote input computer in data communication with the database; and at least one remote output computer in data communication with the database. The database includes machine readable instructions for: directing a user to at least one specific portion of the database in accordance with a status associated with the respective user; editing the database to include evidence relating to treatments using at least one respective remote input computer; editing the database to include evaluations of the treatments based on the evidence relating to the treatments in the database using at least one respective remote input computer; and allowing end users to view evaluation information in the database using at least one respective remote output computer.

### BRIEF DESCRIPTION OF THE DRAWINGS

FIG. 1 shows a method for securing and providing evidence-based evaluations of medical treatments for various healthcare conditions according to an embodiment.

FIG. 2 shows a schematic representation of a system for securing and providing evidence-based evaluations of medical treatments for various healthcare conditions according to an embodiment.

FIG. 3 shows a classification system used by a database according to an embodiment

FIGS. 4a through 5d are exemplary screen shots showing visual representations of machine readable instructions contained in a database according to various embodiments.

### DETAILED DESCRIPTION

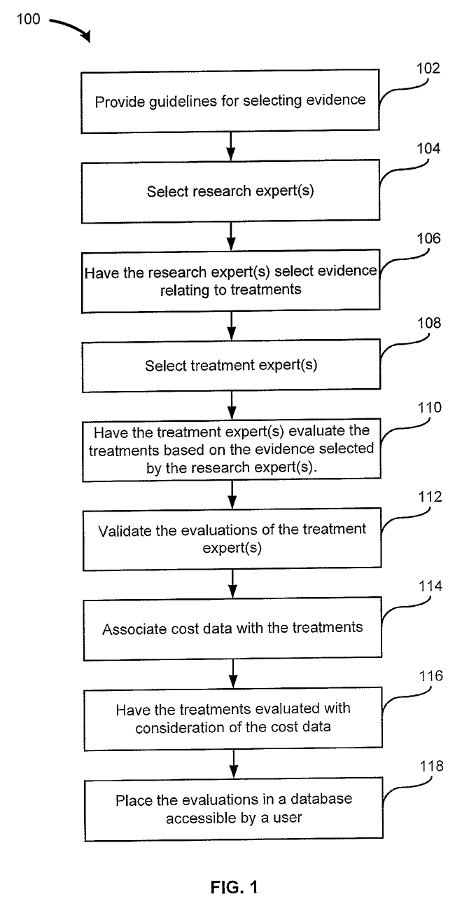

FIG. 1 shows a method 100 for securing and providing evidence-based evaluations of medical treatments (e.g., prescription drugs, non-prescription drugs, medical procedures, etc.) for various healthcare conditions. The method 100 includes: step 102, providing guidelines for selecting evidence about the treatments; step 104, selecting at least one research expert knowledgeable about evidence relating to the treatments; step 106, having the research expert(s) select evidence relating to the treatments; step 108, selecting at least one treatment expert knowledgeable about the treatments; step 110, having the treatment expert(s) evaluate the treatments based on the evidence relating to the treatments; step 112, validating the evaluations of the treatments; step 114, associating cost data with the treatments; step 116, having the treatments evaluated with consideration of the cost data; and step 118, placing the evaluations in a database accessible by a user. The steps of the method 100 are set forth in detail below. It should be appreciated that many of the steps disclosed herein may be performed in various orders, and unless the performance of a step depends on the prior, concurrent, or later performance of another step, a time-order should not be required. In addition, steps may be added to or removed from specific embodiments of methods discussed herein and still remain within the scope of the accompanying claims.

At step 102 of method 100, guidelines may be provided to ensure that evidence about the treatments is valid, relevant, unbiased, etc. For example, a guideline may disallow evidence appearing in a publication that is not peer-reviewed, a guideline may disallow evidence appearing in a publication that is funded by a biased party, etc. The guidelines may be created by one or more research expert, one or more treatment expert, and/or other appropriate people. Stringent guidelines on the selection of clinical evidence may provide additional value to the method 100.

At step 104 of method 100, the research expert(s) may be selected by an administrator of the method 100 (i.e., a person or a committee overseeing the method 100) and/or other appropriate people. Research experts may be research-oriented physicians, academic-oriented physicians, certified specialists who typically care for the healthcare condition being treated, and/or other appropriate people or systems. A plurality of research experts may be referred to herein as a Medical Advisory Committee (or “MAC”), and research experts selected based on a demonstrated background in evidence-based research along with their knowledge as a thought-leader or medical expert in their respective field may provide additional value to the method 100.

At step 106 of method 100, the research expert(s) may select evidence relating to the treatments from specific randomized clinical trials, published clinical evidence, systematic reviews, meta analysis, publications, and/or other appropriate sources. To select evidence, a research expert may rely on his background and knowledge of the healthcare condition and/or the source of the evidence. The research expert(s) may additionally or alternately rely on the guidelines for selecting evidence about the treatments set forth in step 102. If the guidelines set forth in step 102 are not relied upon when selecting evidence relating to the treatments, the guidelines set forth in step 102 may be used to filter or verify the quality of the selected evidence.

At step 108 of method 100, the treatment expert(s) may be selected by an administrator of the method 100 (i.e., a person or a committee overseeing the method 100) and/or other appropriate people. Treatment experts may be clinically-oriented physicians, certified specialists who typically care for the healthcare condition being treated, and/or other appropriate people or systems. Treatment experts selected based on a demonstrated background in patient treatment and/or prestigious affiliations/recognitions in their respective field may provide additional value to the method 100. For example, treatment experts may be selected based on their affiliation with the top fifty academic medical centers as determined by the annual RTI and University of North Carolina Physician Evaluation. It may be desirable to have some or all treatment experts that are not also research experts to provide a variety of opinions and meaningful review.

At step 110 of method 100, the treatment experts may evaluate the treatments based on the evidence selected by the research expert(s). The treatments may be evaluated for traits such as effectiveness, safety, tolerability, etc., and the treatment experts may further provide an overall ranking (also referred to herein as “overall evaluation”) based upon a combination of the traits. To determine an overall ranking, the treatment experts may consider the traits that are most important to an overall ranking for a specific healthcare condition and those that are less important. For example, effectiveness may be the most important trait to one healthcare condition, while tolerability or safety may be the most important trait to another healthcare condition.

At step 112 of method 100, to validate the evaluations of the treatments provided in step 110, the treatment experts may be required to answer one or more question concerning their judgment used in the evaluation process. These answers may be reviewed by other treatment experts and/or other appropriate people to ensure that the treatment experts used good judgement. Additionally, or alternately, evaluations may be peer-reviewed by MAC members and/or other appropriate people for reasonableness and appropriateness.

At step 114 of method 100, cost data may be associated with the treatments. Cost data may be on a daily or average monthly basis, for example, and may be set forth as a standard retail cost and/or as a cost under a health plan.

At step 116 of method 100, the treatments may be evaluated with consideration of the cost data provided at step 114. The evaluation may only compare the costs associated with various treatments, or the evaluation may combine cost with at least one other ranking as set forth in step 110 to determine an overall ranking that includes cost as a component.

At step 118 of method 100, the evaluations may be placed in a database accessible by a user, such as an individual healthcare consumer, an employer, an employee, a health plan member, a healthcare provider, a physician, a nurse, an insurance company, etc. The database may be free of charge or may require an access fee, and the database may be generally accessible or may have a restricted audience. The database may be accessible in various ways, such as through the internet, through a local network, etc.

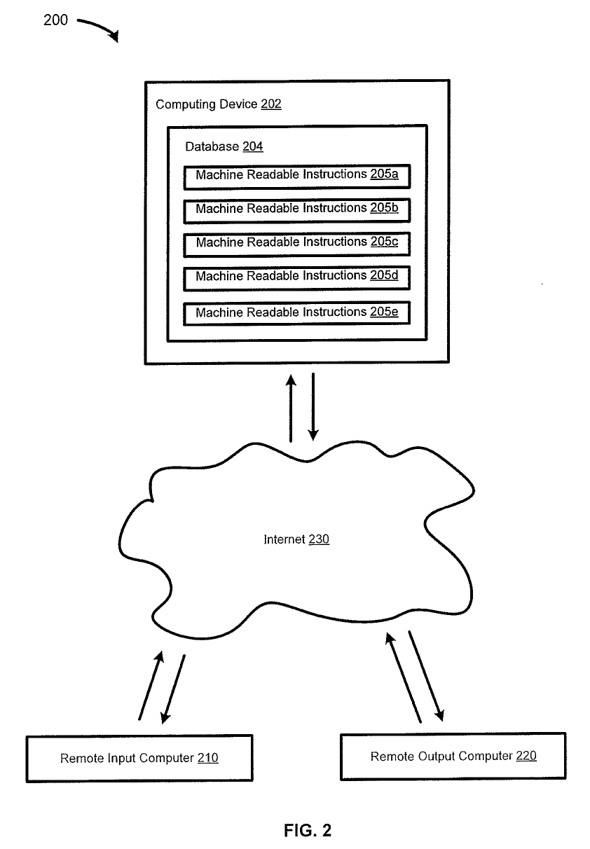

FIG. 2 shows a system 200 for securing and providing evidence-based evaluations of medical treatments (e.g., prescription drugs, non-prescription drugs, medical procedures, etc.) for various healthcare conditions. The system 200 includes a computing device 202 having a database 204 stored therein, at least one remote input computer 210, at least one remote output computer 220, and a network (e.g., the internet) 230 allowing data communication between the remote computer(s) 210, 220 and the database 204. A remote input computer 210 may or may not also be a remote output computer 220.

The database 204 includes machine readable instructions 205a for directing users to specific portions of the database 204 in accordance with a status associated with a respective user, machine readable instructions 205b for editing the database 204 to include evidence relating to treatments, machine readable instructions 205c for editing the database 204 to include evaluations of the treatments based on the evidence relating to the treatments in the database 204, machine readable instructions 205d for allowing end users to view evaluation information in the database 204, and machine readable instructions 205e for allowing administrators to setup the database 204. The machine readable instructions 205a may, for example, direct a research expert to a portion of the database 204 that includes the machine readable instructions 205b, direct a treatment expert to a portion of the database 204 that includes the machine readable instructions 205c, and direct an end user to a portion of the database 204 that includes the machine readable instructions 205d. Even more particularly, the machine readable instructions 205a may direct research and treatment experts to portions of the database 204 that include the machine readable instructions 205b, 205c for specific medical conditions.

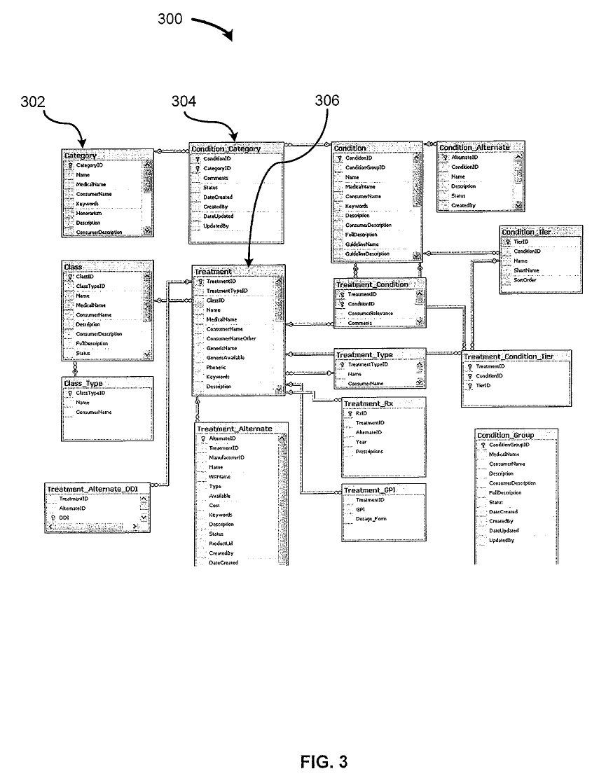

The database 204 may include a classification system 300 such as that shown in FIG. 3. For example, treatments may be classified into a hierarchy based on medical categories 302 (high level categorizations that may be used to facilitate the creation of evaluations based on a grouping of conditions corresponding to specialities and that may be used to facilitate logical grouping of conditions for display to an end user,) medical conditions 304 (diseases or conditions that exist within each medical category,) and treatments 306 (prescription drugs, non-prescription drugs, procedures, equipment, devices, lifestyle changes, alternative medicine, etc.). Medical categories 302 may be created solely for the end user (e.g., “Children's Health”), or may be used for the creation of evaluations as well as for the end user (e.g., “Cardiovascular Diseases”). A pharmaceutical product for treating high cholesterol, for example, may be classified in the database 204 in a “Cardiology” category and a “High Cholesterol” condition. Medical conditions 304 may be classified under one or more medical categories 302, but each medical condition 304 may be distinct from each other medical condition 304. Related medical conditions 304 may form “condition groups” that may be of particular value to end users searching through medical conditions 304 in the database 204. Treatments 306 may exist once in the database 204 but may be associated with multiple conditions 304. For example, the treatment Toprol ZL may be associated with the medical conditions of “Hypertension”, “Headaches”, and “Heart Failure”.

Information may be associated with the medical categories 302, the medical conditions 304, and/or the treatments 306 in the database 204 as further shown in FIG. 3. For example, text that describes a medical category 302 may be associated with that medical category 302, and text that describes a medical condition 304 may be associated with that medical condition 304. Treatments 306 may be associated with FDA data, generic drug names, proprietary drug names, cost data, side effects, classification designations, etc.

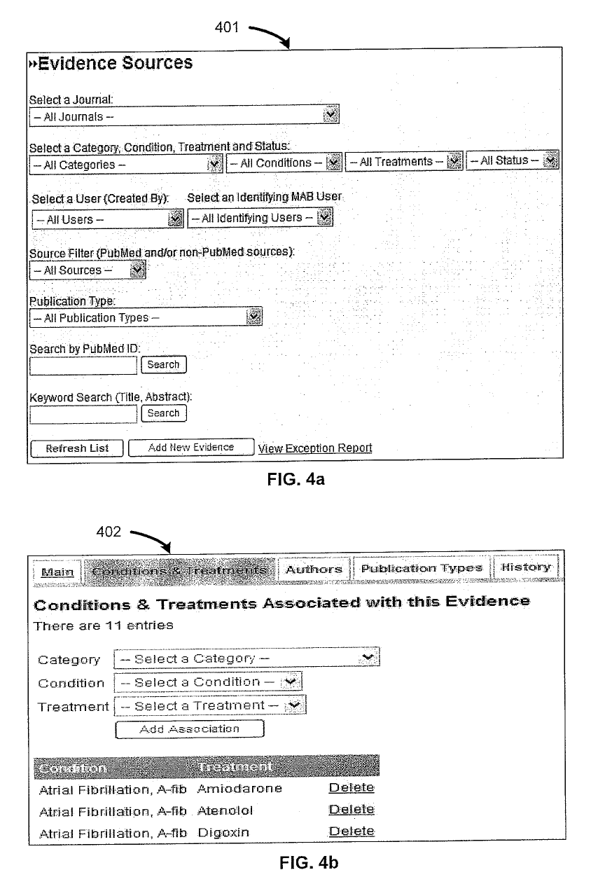

FIGS. 4a and 4b show a visual representation of part of the machine readable instructions 205b for editing the database 204 to include evidence relating to treatments. More particularly, FIGS. 4a and 4b show input screens 401, 402 at which evidence relating to treatments may be input into the database 204 and related to a particular treatment 306, medical condition 304, and medical category 302. The evidence used in FIG. 4a is articles from medical journals, though other evidence (e.g., clinical trials, published clinical evidence, systematic reviews, meta analysis, publications, and/or other appropriate sources) may additionally or alternately be used. Research experts may select and input the evidence relating to treatments into the database 204 using the machine readable instructions 205b and respective remote input computers 210. For example, the research experts may select the evidence from other computer databases via the internet. The research experts may rely on guidelines for selecting evidence about the treatments 306, or guidelines may be used to filter or verify the quality of the selected evidence. The database 204 may include copies of the input evidence, abstracts of the input evidence, and/or references to the input evidence. The database 204 may save information related to the input evidence (e.g., author information, clinic information, etc.) in a searchable format for future reference.

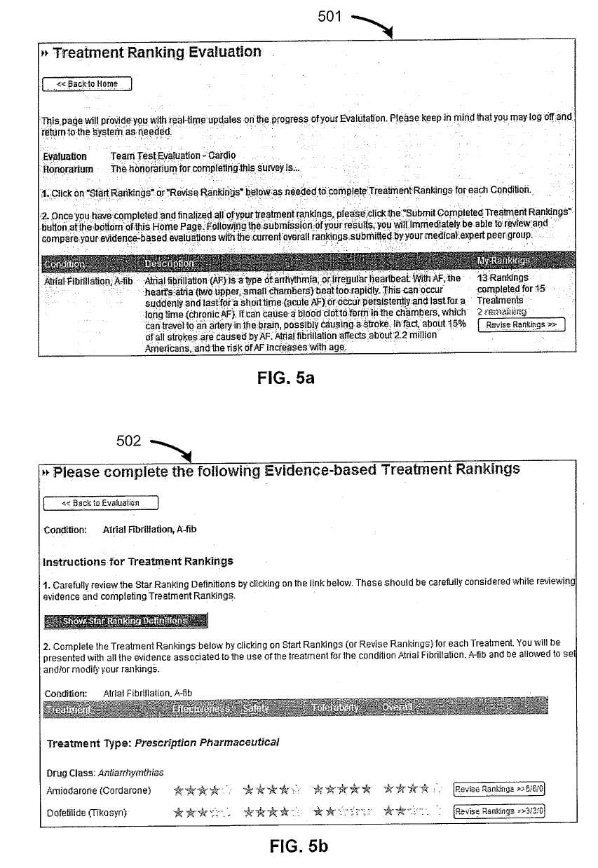

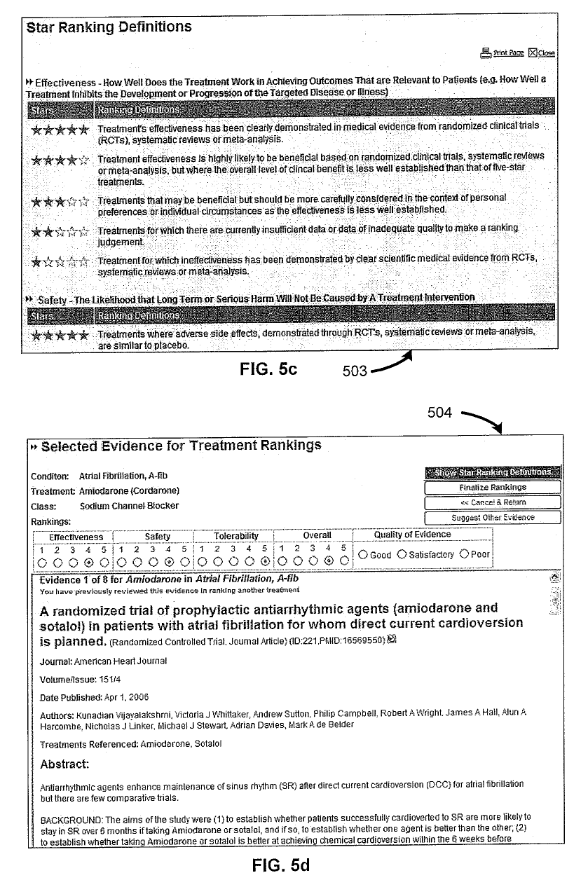

FIGS. 5a through 5d show a visual representation of part of the machine readable instructions 205c for editing the database 204 to include evaluations of the treatments 306 based on the evidence relating to the treatments in the database 204. The machine readable instructions 205c provide functionality to carefully control the input of evaluations by treatment experts using various constraints, system variables, and process flow. Upon login through a remote input computer 210, each treatment expert may be presented with a dashboard showing all evaluations (also referred to herein as “rankings”) assigned to him (typically only one evaluation at a time) and any applicable honorarium. Evaluations may be assigned automatically (such as based the expertise of treatment experts) or may be otherwise assigned. Upon selecting (or proceeding to) an evaluation, the treatment expert may be presented with all of the medical conditions 304 that apply based on the setup of the evaluation, how many treatment rankings remain, and the option of proceeding with evaluations or revising evaluations (as shown in exemplary screenshot 501 in FIG. 5a). In entering evaluations, all of the forms of treatment 306 for a given medical condition 304 may be displayed, categorized by the treatment type, and grouped as desired (as shown in exemplary screenshot 502 in FIG. 5b). The evaluations may be in the form of a scaled ranking, such as on a scale of 1 to 10, a number of stars (as shown in exemplary screenshot 503 in FIG. 5c,) etc.

In entering evaluations for a treatment 306, the treatment expert may be provided and required to review all of the evidence in the database 204 selected by the research experts. For each treatment 306, the total number of pieces of evidence in the database 204 may be displayed, as well as whether or not the treatment expert has reviewed each piece of evidence; evidence not yet reviewed may be displayed by the database 204 before evidence already reviewed is displayed. As illustrated in exemplary screenshot 504 in FIG. 5d, the treatment expert may be required to rank the treatment 306 in terms of effectiveness, safety, tolerability, quality of evidence in the database 204, and/or other features. The treatment expert may provide an overall ranking, or an overall ranking may be calculated based on other rankings provided by the treatment expert. A comparison of the treatment expert's rankings to the rankings of other treatment experts may be provided to the treatment expert providing the evaluation. As also illustrated in FIG. 5d, the machine readable instructions 205c may allow the treatment expert to suggest additional evidence for inclusion in the database 204 and/or may allow the treatment expert to save progress, log off, and return to the database 204 where he last ended.

The machine readable instructions 205d for allowing end users to view evaluation information in the database 204 may allow an administrator, a research expert, a treatment expert, or another appropriate entity to review individual evaluations for oddities and to approve the individual evaluations for publication via the internet, a local network, etc. Before publishing the evaluations, the machine readable instructions 205d may tabulate, normalize, average, and/or perform other operations on the evaluations. Once published, the machine readable instructions 205d may allow end users to access the evaluations in the database 204 on the output computers 220, such as through search routines, an index, graphic links, etc. Login routines may be required to allow only selected end users to access the database 204, and specific interfaces may be provided to various end users. For example, various employers or insurance companies may have specific interfaces for end users. End users may be allowed to input personal medical information, such as a medical condition 304, age, sex, race, prior drug utilization, history of illness, blood test results, urine test results, health status, health history, current drug utilization, results of medical examinations related to the medical condition, priority of effectiveness, priority of safety, priority of tolerability, priority of cost, etc., to access the evaluations in the database 204 and effectively obtain a personalized medical plan.

Those skilled in the art appreciate that variations from the specified embodiments disclosed above are contemplated herein and that the described embodiments are not limiting. The description should not be restricted to the above embodiments, but should be measured by the following claims.

What is claimed is as follows:

1. A method of securing and providing evidence based evaluations of medical treatments comprising:
(a) providing guidelines for selecting evidence about the treatments;
(b) selecting a research expert knowledgeable about evidence relating to the treatments;
(c) having the research expert select evidence relating to the treatments;
(d) selecting a group of treatment experts knowledgeable about the treatments;
(e) having the treatment experts evaluate the treatments based on the evidence relating to the treatments; and
(f) placing the evaluations in a database accessible by users.

2. The method of claim 1, wherein at least one of the treatments includes the use of drugs.

3. The method of claim 2, wherein the evaluations include at least one concept selected from the group consisting of effectiveness, safety, tolerability, and cost.

4. The method of claim 2, wherein the evaluations include at least two concepts selected from the group consisting of effectiveness, safety, tolerability, and cost.

5. The method of claim 2, further comprising the step of forming an overall evaluation based on at least two of the evaluations.

6. The method of claim 1, wherein:
the database includes information about medical conditions, information about the treatments, classifications of the conditions, classifications of the treatments, and published evidence associated to the treatments;
the research expert provides the published evidence to the database; and
the treatment experts provide the evaluations to the database.

7. The method of claim 6, wherein the evaluations are provided to the database via the internet.

8. The method of claim 6, further comprising the steps:
(g) securing personal medical information from a consumer related to a specific medical condition to be treated by the treatments;
(h) securing selection criteria from the consumer, the selection criteria selected from the group consisting of effectiveness, safety, tolerability, and cost;
(i) preparing a personalized medical plan for the consumer based on the personal medical information, the treatment evaluations, and the selection criteria; and
(j) providing the personalized medical plan to at least one of the consumer and a healthcare provider.

9. The method of claim 1, wherein each evaluation comprises at least one of a series of numbers, stars, and symbols.

10. The method of claim 1, wherein the evidence comprises published clinical evidence.

11. The method of claim 1, wherein the evaluations are accessible from the computer database via the internet.

12. The method of claim 1, wherein the evidence is selected from computer databases via the internet.

13. The method of claim 1, wherein the treatment experts evaluate the treatments based on guidelines.

14. The method of claim 1, wherein the treatments are placed in categories and subcategories relating to specific medical conditions.

15. The method of claim 14, wherein separate research experts and separate treatment experts are selected for each category and subcategory.

16. A method of providing personalized medical plans for consumers, the method comprising:
(a) providing a database of treatment evaluations based on evidence relating to the treatments;
(b) securing personal medical information from the consumers related to medical conditions to be treated by the treatments;
(c) securing selection criteria from the consumers, the selection criteria selected from the group consisting of effectiveness, safety, tolerability, and cost;
(d) preparing personalized medical plans for the consumers based on the personal medical information, the treatment evaluations, and the selection criteria; and
(e) placing the personalized medical plans in a database accessible by at least one of the consumers and a healthcare provider.

17. The method of claim 16, wherein the evidence comprises published clinical evidence.

18. The method of claim 17, wherein the treatment evaluations comprise rankings prepared by treatment experts based on the evidence.

19. The method of claim 18, wherein the rankings comprise at least one of a series of numbers, stars, and symbols.

20. The method of claim 16, wherein the personal medical information includes at least one item selected from the group consisting of age, sex, race, prior drug utilization, history of illness, blood test results, urine test results, health status, health history, current drug utilization, and results of medical examinations related to the medical conditions to be treated by the treatments.

21. A system for securing and providing evidence-based evaluations of medical treatments for various healthcare conditions, the system comprising:
a computing device having a database;
at least one remote input computer in data communication with the database; and
at least one remote output computer in data communication with the database;
wherein the database includes machine readable instructions for:
directing a user to at least one specific portion of the database in accordance with a status associated with the respective user;
editing the database to include evidence relating to treatments using at least one respective remote input computer;
editing the database to include evaluations of the treatments based on the evidence relating to the treatments in the database using at least one respective remote input computer; and
allowing end users to view evaluation information in the database using at least one respective remote output computer.
